(19) United States
(12) Patent Application Publication
(10) Pub. No.: US 2025/0051075 A1
(43) Pub. Date: Feb. 13, 2025

(54) MULTI-COMPARTMENTAL PEEL / RESEAL LABEL AND PACKAGING

(71) Applicant: C.P. Converters, Inc., York, PA (US)

(72) Inventor: Daniel R. COLLINS, II, Victor, NY (US)

(21) Appl. No.: 18/799,104

(22) Filed: Aug. 9, 2024

Related U.S. Application Data
(60) Provisional application No. 63/518,603, filed on Aug. 10, 2023.

(51) Int. Cl. B65D 77/20; B65C 1/02

(52) U.S. Cl. CPC B65D 77/2096; B65C 1/02; B65D 2203/02

(57) ABSTRACT

A multi-compartmental peel/reseal package having a peel/reseal label member. The multi-compartmental peel/reseal package includes a substrate forming at least a portion of a package body. The substrate includes a plurality of circumferential slits in the substrate, each circumferential slit defining an opening cover corresponding to an opening in the package body. The label member is adhered to the substrate and is configured to cover the plurality of circumferential slits and seals the openings. A selectively applied adhesive is present on a surface of the label member forming a high tack area and a low tack area. The positioning of the high tack area provides attachment of the label member to the substrate and seal each of the openings in the package body. The positioning of the low tack area permits peeling and release of the label member from the substrate.

### CROSS REFERENCE TO RELATED APPLICATIONS

This application is a non-provisional patent application claiming priority and benefit of U.S. Provisional Patent Application No. 63/518,603, filed Aug. 10, 2023, entitled “MULTI-COMPARTMENTAL PEEL/RESEAL LABEL”, which is hereby incorporated by reference in its entirety.

### FIELD OF THE INVENTION

The present disclosure is generally directed to a multi-compartmental packaging including multi-compartmental packaging having peel/reseal label members.

### BACKGROUND OF THE INVENTION

Products such as food and personal care items are provided in packages or storage structures that provide for access to those food or personal items. The packages protect the product from damage during shipping and handling; seal the product to prevent the product from deterioration due to environmental conditions for predetermined periods of time and as a storage vessel. Once opened, while most containers can be reclosed, the effectiveness of the closing arrangement varies widely.

A typical package for storage of food or personal care items is made from a laminate that includes an outer film layer adhesively secured to an inner sealing layer. The outer layer is usually made from a material that facilitates printing. The inner layer is usually made from a material that enables the package to be sealed. Certain known packages for resealing packages include a flap or material that pull away from the package to reveal an opening to access the food or personal care item contained therein. These flaps are resealable by use of pressure sensitive adhesive or similar adhesive material that seal the flap against the storage structure to seal the food or personal care item from the environment. However, such known systems lack the ability to seal multiple food and/or personal care items in a single storage structure. In addition, known resealing package arrangements also are prone to damage from adhesive stretching and/or tearing the packaging material during the peeling and resealing process.

What is needed is a packaging solution that permits sealing and resealing of products, such as food and personal items, that does not suffer from the disadvantages of the prior art. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

A peel/reseal label member that adheres and provides access to multi-compartments of a package. The label member provides sealing of each of the compartments of the multiple compartments of the package. A sustainable solution for consumer convenience and product consolidation. The sealing is provided by selective application of adhesive and/or the variation in adhesive to vary the adhesive strength of the applied adhesive.

One embodiment of the present disclosure is directed to a method for forming a multi-compartmental peel/reseal package. The method includes providing a substrate forming at least a portion of a package body and forming a plurality of circumferential slits into the substrate to form a cut substrate. Each circumferential slit defines an opening cover corresponding to an opening in the package body. A label member is provided, the label member being configured to cover the plurality of circumferential slits and seal the opening in the package body when adhered to the substrate. An adhesive is selectively applied to the label member to form a high tack area and a low tack area on the label member. The high tack area has a greater adhesive tack value than the low tack area. The label member is applied to a landing area on the substrate to seal the circumferential slits. The landing area includes the opening covers. The positioning of the high tack area provides attachment of the label member to the substrate and seal each of the openings in the package body. The positioning of the low tack area permits peeling and release of the label member from the substrate.

Another embodiment of the present disclosure includes a multi-compartmental peel/reseal package. The multi-compartmental peel/reseal package includes a substrate forming at least a portion of a package body. The substrate includes a plurality of circumferential slits in the substrate, each circumferential slit defining an opening cover corresponding to an opening in the package body. A label member is adhered to the substrate and is configured to cover the plurality of circumferential slits and seal the openings in the package body. A selectively applied adhesive is present on a surface of the label member forming a high tack area and a low tack area. The high tack area has a greater adhesive tack value than the low tack area. The positioning of the high tack area provides attachment of the label member to the substrate and seal each of the openings in the package body. The positioning of the low tack area permits peeling and release of the label member from the substrate.

Another embodiment of the present disclosure includes a multi-compartmental peel/reseal label member for packaging. The multi-compartmental peel/reseal label member includes a label member configured to cover the plurality of circumferential slits and seal the opening in the package body when adhered to the substrate. A selectively applied adhesive is present on a surface of the label member to form a high tack area and a low tack area. The high tack area has a greater adhesive tack value than the low tack area. The positioning of the high tack area allows attachment of the label member to the substrate and is capable of sealing each of the openings in the package body. The positioning of the low tack area permits peeling and release of the label member from the substrate.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

FIG. 1 shows a multi-compartmental peel/reseal package according to an embodiment of the present disclosure in a sealed position.

FIG. 2 shows the multi-compartmental peel/reseal package of FIG. 1 in a partially peeled position.

FIG. 3 shows a label member prior to application of adhesive according to a method according to the present disclosure.

FIG. 4 shows the label member of FIG. 3 after application of the adhesive according to a method according to the present disclosure.

FIG. 5 shows the label member of FIG. 4 after modification of the adhesive according to a method according to the present disclosure.

FIG. 6 shows a multi-compartmental peel/reseal package prior to formation of the substrate into a package body according to an embodiment of the present disclosure in a sealed position.

FIG. 7 shows a process flow according to an embodiment of the present disclosure in a sealed position.

FIG. 8 schematically shows a manufacturing process flow according to an embodiment of the present disclosure in a sealed position.

Wherever possible, the same reference numbers will be used throughout the drawings to represent the same parts.

### DETAILED DESCRIPTION OF THE INVENTION

Embodiments of the presently disclosed invention include peel/reseal label members that adhere and are functional on substrates, such as die cut rollstock, that provide access to multiple compartments either in a packaging body or other package configuration. The multi-compartmental peel/reseal package and method according to an embodiment of the present disclosure provide a sustainable solution for consumer convenience and product consolidation. The sealing is provided by selective application of adhesive and/or the variation in adhesive to vary the adhesive strength of the applied adhesive resulting in little or no damage during peeling and resealing of the label member. Additional advantages include added product freshness to compartments not opened and ability to add different components to compartments within the same package.

An important element of certain embodiments of the present disclosure is the application and/or modification of the adhesive on the label. For example, in one embodiment, the adhesive bond value or tack value is lowered in pre-selected portions of the land area, such as between compartments, to enable the peel and reseal attributes around the compartments. In these embodiments, for example, the adhesive tack value change or reduction, in certain embodiments, may be up to 50% less tack value than the tack value of the adhesive in the non-land area between compartments. This variation is a significant development to permit the advantage of the multi-compartmental peel/reseal labels according to the present disclosure. Absence of this variance in adhesive tack values may result in tearing of the packaging in the land area between the cut compartments.

According to an embodiment of the present disclosure, the peel/reseal label member system includes a die cut that includes multiple compartments. The die cut includes openings corresponding to the multiple compartments of the packaging.

According to another embodiment of the present disclosure, the peel/reseal label member system includes a label member that allows access to each compartment of the package and reseals to maintain product freshness. The label member includes pressure sensitive adhesive or similar adhesive material that seal the label member against the storage structure to seal the food or personal care item from the environment. The sealing is provided by selective application of adhesive and/or the variation in adhesive to vary the adhesive strength of the applied adhesive.

The peel/reseal label system according to the present disclosure may, for example, include, the use of printed rollstock, a label member that is of a specific size for functionality and equipment that die cuts the rollstock and applies the label member. The peel/reseal system includes several openings within the package for access to different products within the package. Embodiments according to the present disclosure include specific die configurations, including the ability to cut multiple opening. In addition, the present disclosure includes specific label design to provide access to all compartments.

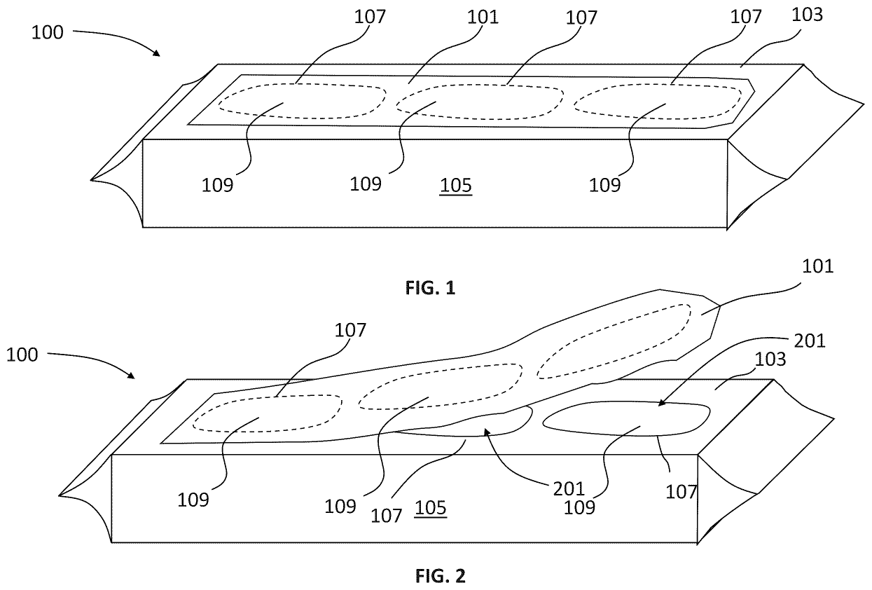

FIG. 1 shows a multicompartment package 100 according to an embodiment of the present disclosure. The multicompartmental package 100 includes a label member 101 in a sealed position, adhered to a substrate 103. Substrate 103 is a portion of a package body 105. This portion includes a landing area or other surface onto which the label member 101 may be adhered to seal the package 100. The substrate 103 and the package body 105 may be formed from any suitable packaging material, including, but not limited to polyethylene (PE), polypropylene (PP), polyethylene terephthalate (PET), and combinations and variations thereof. In a particularly suitable embodiment, the material for the substrate 103 and/or the package body 105 includes food-grade polyethylene, polypropylene or polyethylene terephthalate. Substrate 103 is also a unique component for the success of the multicompartmental package 100. The multicompartmental package 100 may be is configured with multiple layers that are created using a lamination. Thicknesses for the multiple layers forming the substrate 103 may range from, for example, about 0.0005 to about 0.005 inches. The substrate 103 preferably has a stiffness that is comparable to the label member 101 to maintain integrity while the label member 101 is peeled and resealed. Also, substrate 103 must have the ability to be cut, such as by die cutting, to form the circumferential slits 107 and allow access to the various compartments within the package body 105. The circumferential slits 107 should be made with a geometry that does not propagate or tear as the label member 101 is peeled and resealed. In one embodiment, the substrate 103 may be, for example, flow wrap, which wraps around a tray (or other structure) and seals on the ends and back seal. In another embodiment substrate 103 may be a cover or lidding material that may be sealed to a ridged container.

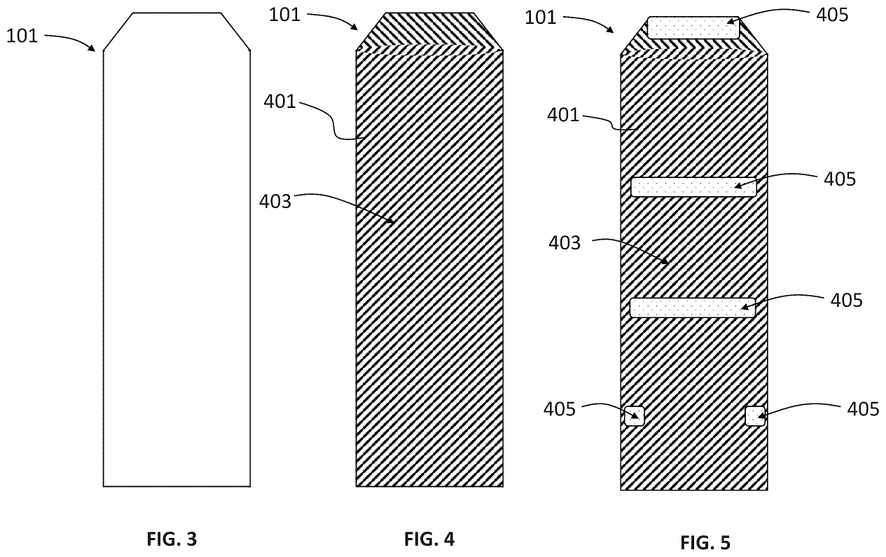

The package body 105 is not limited to the configuration shown in FIG. 1 and may include any suitable geometric configuration of packaging that permits storage of a product or good. For example, the package 100 may be configured to store and dispense food or personal items. Additional structures, although not shown in FIG. 1, may be included on or within the package body 105. For example, stiffeners, trays, separators, baffles, flaps or other structures known in the packaging art may be included on or within the package body 105. The multicompartmental package 100 has circumferential slits 107 (shown in dotted lines in FIG. 1 to show placement under label member 101). The circumferential slits 107 are cut openings in the substrate 103 that define openings 201 (see for example, FIG. 2) that allow access into the package body 105. Circumferential slits 107, as utilized herein, means slits, slices or cuts formed through the substrate 103 in a pattern to define an opening 201 in the package body 105. In one embodiment, the circumferential slits 107 are formed by die cutting. The circumferential slits 107 may be formed in any suitable geometry to form openings 201 and to provide access to the package body 105. The circumferential slits 107 preferably define a perimeter completely around opening 201, but may also include a partial perimeter, for example, to provide a flap-like opening 201. In another embodiment, the circumferential slits 107 are formed in a geometry that reduces or eliminates pulling, stretching or breaking of the material of the substrate 103. All of the above components have ranges of tolerances to make a peel/reseal multicompartmental package 100 that provides the functionality of the storing and sealing products or goods.

In addition to defining openings 201, circumferential slits 107 define opening covers 109 (shown in dotted lines in FIG. 1 to show placement under label member 101) that have been cut from the material of the substrate 103. The opening cover 109 has the geometry defined by the circumferential slit 107 and provides a cover at or over the opening 201 when the label member 101 is in the sealed position.

As shown in FIG. 2, the label member 101 is peeled away from the package body 105, to expose openings 201 defined by circumferential slits 107. As shown, the label member 101 lifts the opening covers 109 upon disengagement of the label member 101 from the substrate 103. The opening covers 109 provide additional sealing of the openings 201 of the package body 105. In addition, the opening covers 109 provide a barrier between adhesive 401 and the contents of the package body 105. Peel, peeled, and grammatical variations thereof, as utilized herein, means that the label member 101 is pulled away from the substrate 103 and disengages from the substrate 103 to provide access to the underlying openings 201. Seal, sealed, sealing and grammatical variations thereof, as utilized herein, means that the label member 101 attaches or reattaches to the substrate 103 in a manner that prevents or inhibits the transmission of air, moisture and/or fluids into the package through the opening 201.

FIGS. 3-5 shows the stages for selective application of adhesive 401 to label member 101 according to an embodiment of the present disclosure. FIG. 3 shows a label member 101 as provided made of a material suitable for packaging. The label member 101 may be a multiple layer structure, composite, or laminate. The composition of the multiple layers is preferably a composition that provides rigidity to prevent the label member 101 from stretching when being peeled and also allows the label member 101 to be applied to the substrate 103 and return to an original position on the substrate 103 when being resealed. The label member 101 may be fabricated from the same or different than the material of the substrate 103. Suitable materials for the label member 101 may include, for example, polyethylene (PE), polypropylene (PP), polyethylene terephthalate (PET), and combinations and variations thereof. Examples of multilayer structures for label member 101 may include but are not limited to, for example, PET/PP, PET/PE, PP/PP, PP/PE, or PE/PE. In addition, thicknesses for the multiple layers forming the label member 101 may range from, for example, about 0.0005 to about 0.005 inches. FIG. 4 shows the label member 101 of FIG. 3 where an adhesive 401 is applied to a surface thereof. Although FIG. 4 shows a complete coverage of one surface of the label member 101, the present disclosure is not so limited and more or less of the label member 101 may include adhesive 401. Adhesive 401 may be a pressure sensitive adhesive. The application of adhesive 401 according to an embodiment of the present disclosure results in a high tack area 403. FIG. 5 shows an additional step according to an embodiment of the present disclosure where a selectively applied adhesive including a high tack area 403 and a low tack area 405. The high tack area 403 includes a greater adhesive tack value than the low tack area 405. The positioning of the high tack area 403 provides attachment of the label member 101 to the substrate 103 and seal each of the openings 201 in the package body 105. The positioning of the low tack area 405 permits peeling and release of the label member 101 from the substrate 103. In addition, position of the low tack area 405 provides the ability for the substrate 103 and/or package body 105 to have portions of thinner or smaller areas of the substrate 103, for example in the areas between openings 201. In this embodiment, the low tack area 405 prevents ripping or pulling of the thinner or smaller areas between openings 201 during peeling of the label member 101. While the above describes a high tack area 403 and a low tack area 405, additional areas having other tack values including a plurality of tack values between the high tack area 403 and the low tack area 405, may be provided for additional functionality.

The adhesive 401 applied to the label member 101 may be, for example, a pressure sensitive adhesive that is selectively applied or calendared in a uniform manner. The application of the adhesive 401 may be provided in according to any suitable know method for application of adhesive material to polymer substrates. The chemical composition of the pressure sensitive adhesive can be varied and is dependent upon the end use and required resistant properties. Examples to be considered include an adhesive 401 that used for food packaging, such as cookie packaging, would be different that an adhesive used for wet wipe packaging. For example, in a wet wipe packaging, the adhesive would have the property of chemical resistance. Adhesive 401 is measured by coating weight as well as tack value. Tack value is measured using a peel value that is measured in grams per square inch. The range of the peel values for the high tack area 403, in one embodiment, is between that of 300 to 700 grams per square inch. In one embodiment, the tack value of adhesive 401 may be lowered to form a in between the multiple compartments associated with the label member functionality. The tack may be lowered to 300 to 400 grams per square inch to allow for release of a landing area without tears the small bridge of film between compartments. The modification or lowering of the adhesive layer may include deadening and may be accomplished by adding a deadening additive, such as a patterned contaminate, into the adhesive 401. Suitable deadening additives may include, but are not limited to acrylics, clays, polybutylene or other known compounds that deaden adhesive compositions. The tack value of the low tack area 405 and the tack value of the high tack area 403 may vary by up to 50% to permit the label member to peel and reseal. For example, the low tack value may be at least 1% or at least 5% or at least 10% or at least 15% or at least 20% or at least 25% or at least 30% or at least 35% or at least 40% or at least 45% or at least 50% less than the value of the high tack value based on the peel value. For example, the low tack value may be at least 1% or at least 5% or at least 10% or at least 15% or at least 20% or at least 25% or at least 30% or at least 35% or at least 40% or at least 45% or at least 50% less than the high tack area value between that of 300 to 700 grams per square inch.

In one embodiment, the selectively applied adhesive 401 includes a modified adhesive that converted a portion of the high tack area 403 to a low tack area 405. In one embodiment, adhesive 401 may be modified to form the modified adhesive in the low tack area 405 by applying a deadening additive. The deadening additive may be a contaminant, solvent, filler material or other additive that modifies adhesive 401 to reduce the tack value. In another embodiment, the selectively applied adhesive includes adhesive 401 applied to pre-selected areas of the label member forming the high tack area 403 and the low tack area 405. In yet another embodiment, the selectively applied adhesive includes a first adhesive composition forming the high tack area 403 and a second adhesive composition forming the low tack area 405. In this embodiment, the first adhesive composition includes a composition that has a high tack value and the second adhesive composition includes a composition that has a low tack value. The high tack value is higher than the low tack value. The high tack value and low tack value may be the same values as described with respect to the high tack value and the low tack value for the high tack area 403 and the low tack area 405, respectively. Although the above describes a high tack area 403 and a low tack area 405, additional areas having other tack values including a plurality of tack values between the high tack area 403 and the low tack area 405, may be provided for additional functionality.

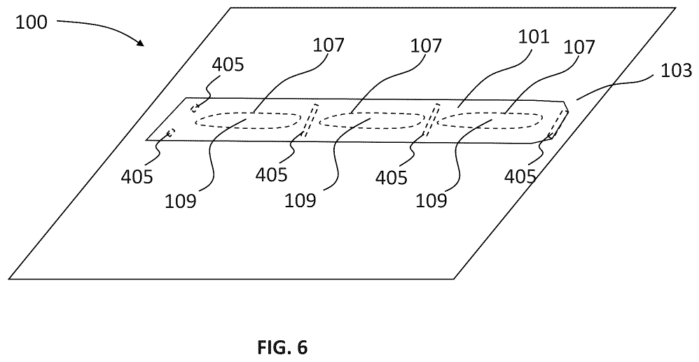

FIG. 6 shows a multicompartmental package 100 prior to assembly of the package body 105. The package 100 shown in FIG. 6 shows the label member 101, substrate 103, circumferential slits 107, opening covers 109 as shown and described with respect to FIGS. 1 and 2. In addition, FIG. 6 shows the placement of adhesive 401 and low tack area 405 as shown and described with respect to FIG. 5. Although not visible in FIG. 6, the circumferential slits 107, the opening covers 109 and low tack areas 405 are shown in broken lines to show positioning underneath label member 101.

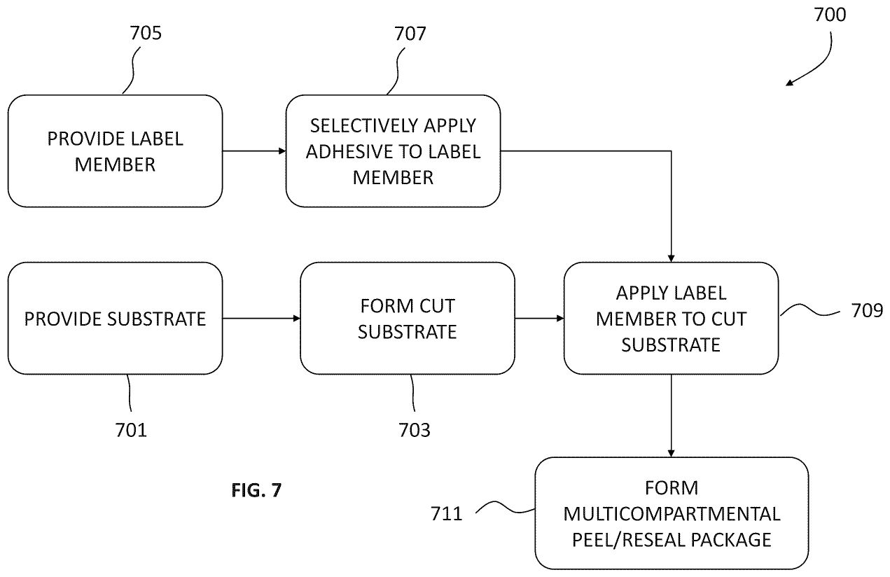

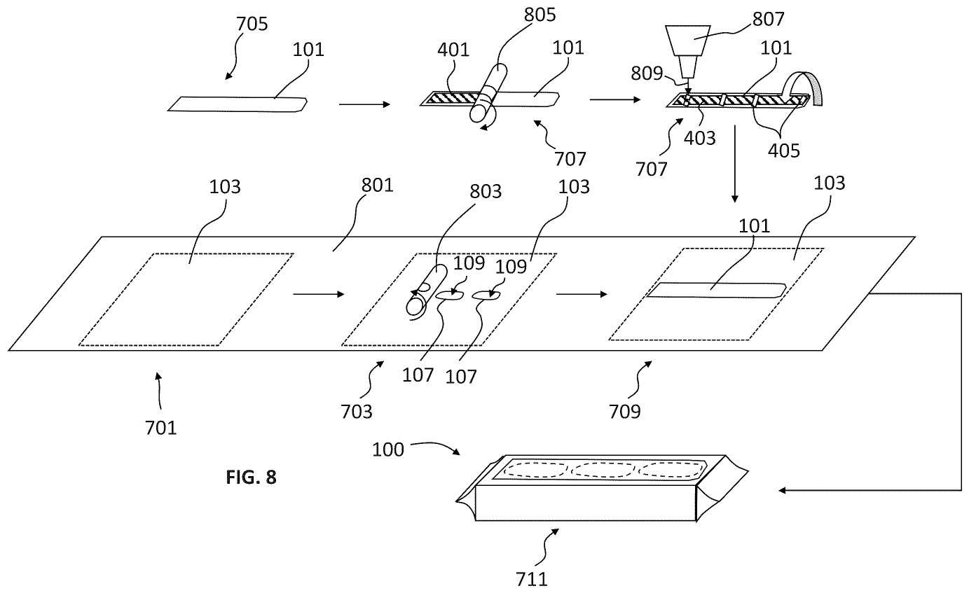

FIGS. 7 and 8 illustrate a method 800 of making a multicompartmental package 100 according to an embodiment of the present disclosure. FIG. 8 schematically shows a manufacturing process for forming the multicompartmental package 100 utilizing the process shown in FIG. 7, according to the present disclosure. As shown in FIG. 7, method 700 includes providing a substrate 103 (step 701) the substrate 103 forming at least a portion of a package body 105. As shown in FIG. 8, the substrate may be a web 801, such as a process material web utilized in known packaging manufacturing processes. A plurality of circumferential slits 107 are formed into the substrate 103 to form a cut substrate 103 (step 703). Each circumferential slit 107 defines an opening cover corresponding to an opening in the package body. The cutting of circumferential slits 107 may be done, as shown in FIG. 8, by a die 803. The cutting and design of the circumferential slits 107 are important components of the multi-compartmental peel reseal label package 100. A specially designed die 803 may be provided for each multiple compartmental package 100. The die 803 corresponds to the desired area of the package to allow access. The die 803 preferably has the ability to cut the material at high speed (for example, over 300 feet per minute). Also, the design of the circumferential slits 107 should correspond to the label member 101 so the substrate 103 does not tear or propagate during peel or reseal.

A label member 101 is provided (step 705). The label member 101 includes the materials and configuration, as described above with respect to FIGS. 3-5. The label member 101 may be configured with a geometry to cover the plurality of circumferential slits 107 and seal the opening 201 in the package body 105 when adhered to the substrate 103 (see also FIGS. 1 and 2). An adhesive 401 is selectively applied to the label member 101 (step 707) to form a high tack area 403 and a low tack area 405 on the label member 101. The high tack area 403 having a greater adhesive tack value than the low tack area 405. In the embodiment shown in FIG. 8, the selectively applied adhesive 401 is first applied to the label member 101 by a calendering roll 805. Thereafter, a deadening additive 809 is applied to the adhesive 401 by an additive applicator 807 to form areas of high tack area 403 and low tack area 405. Thereafter, the label member 101 having the areas of high tack area 403 and low tack area 405 is applied to a landing area of the substrate 103 to seal the circumferential slits 107 (step 709). The landing area is maintained within a tolerance for a functional multiple compartmental peel reseal product. For example, there may be at least 5 millimeters between and around circumferential slit 107. This tolerance allows for consistent surface area of the label member 101 and adhesive 401 to make contact and seal.

Once the label member 101 is applied to the substrate 103, the multi-compartmental package 100 may be formed from the web 801 according to cutting, forming, folding and sealing processes known in packaging technologies. The multi-compartmental package 100 formed includes the structure and functionality as shown and described above with respect to FIGS. 1 and 2. Application and testing of the label members 101 may be implemented to form a functional multi-compartmental package 100 according to the present disclosure. The label members 101 are applied in combination with formation of the circumferential slits 107. In addition, an important feature of the functional multi-compartmental package 100 according to the present disclosure is adhesive integrity wherein the adhesive integrity is consistent so that the label member 101 is reproducibly peeled and resealed to the substrate 103.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A method for forming a multi-compartmental peel/reseal package comprising:
providing a substrate forming at least a portion of a package body;
forming a plurality of circumferential slits into the substrate to form a cut substrate, each circumferential slit defining an opening cover corresponding to an opening in the package body;
providing a label member configured to cover the plurality of circumferential slits and seal the opening in the package body when adhered to the substrate;
selectively applying an adhesive to the label member to form a high tack area and a low tack area on the label member, the high tack area having a greater adhesive tack value than the low tack area; and
applying the label member to a landing area on the substrate to seal the circumferential slits, the landing area including the opening covers;
wherein the positioning of the high tack area provides attachment of the label member to the substrate and seal each of the openings in the package body, and the positioning of the low tack area permits peeling and release of the label member from the substrate.

2. The method of claim 1, wherein the adhesive is a pressure sensitive adhesive.

3. The method of claim 1, wherein selectively applying the adhesive include selectively modifying the adhesive to convert a portion of the high tack area to a low tack area.

4. The method of claim 3, wherein the selectively modifying includes applying a deadening additive to the adhesive in the high tack area to form the low tack area.

5. The method of claim 1, wherein the selectively applying the adhesive to the label member includes applying the adhesive to pre-selected areas of the label member to form the high tack area and the low tack area.

6. The method of claim 1, wherein the selectively applying the adhesive to the label member includes selectively applying a first adhesive composition to form the high tack area and a second adhesive composition to form the low tack area.

7. The method of claim 1, wherein the tack value of the low tack area and the tack value of the high tack area vary by at least 1% to permit the label member to peel and reseal.

8. The method of claim 1, wherein the forming a plurality of circumferential slits includes die cutting the substrate.

9. The method of claim 1, wherein the label member lifts the opening covers upon disengagement of the label member from the substrate.

10. A multi-compartmental peel/reseal package comprising:
a substrate forming at least a portion of a package body;
a plurality of circumferential slits in the substrate, each circumferential slit defining an opening cover corresponding to an opening in the package body;
a label member is adhered to the substrate and is configured to cover the plurality of circumferential slits and seal the opening in the package body; and
a selectively applied adhesive on a surface of the label member to form a high tack area and a low tack area, the high tack area having a greater adhesive tack value than the low tack area;
wherein the positioning of the high tack area provides attachment of the label member to the substrate and seal each of the openings in the package body, and the positioning of the low tack area permits peeling and release of the label member from the substrate.

11. The package of claim 10, wherein the adhesive is a pressure sensitive adhesive.

12. The package of claim 10, wherein the selectively applied adhesive includes a modified adhesive that converted a portion of the high tack area to a low tack area.

13. The package of claim 12, wherein the modified adhesive in the low tack area includes a deadening additive.

14. The package of claim 10, wherein the selectively applied adhesive includes adhesive applied to pre-selected areas of the label member forming the high tack area and the low tack area.

15. The package of claim 10, wherein the selectively applied adhesive includes selectively a first adhesive composition forming the high tack area and a second adhesive composition forming the low tack area.

16. The package of claim 10, wherein the tack value of the low tack area and the tack value of the high tack area vary by at least 1% to permit the label member to peel and reseal.

17. The package of claim 10, wherein the circumferential slits are die cut openings in the substrate.

18. The package of claim 10, wherein the label member lifts the opening covers upon disengagement of the label member from the substrate.

19. A multi-compartmental peel/reseal label member for packaging comprising:
a label member configured to cover the plurality of circumferential slits and seal the opening in the package body when adhered to the substrate; and
a selectively applied adhesive on a surface of the label member to form a high tack area and a low tack area, the high tack area having a greater adhesive tack value than the low tack area;
wherein the positioning of the high tack area allows attachment of the label member to the substrate and is capable of sealing each of the openings in the package body, and the positioning of the low tack area permits peeling and release of the label member from the substrate.

20. The label member according to claim 19, wherein the tack value of the low tack area and the tack value of the high tack area vary by at least 1% to permit the label member to peel and reseal.
